(19) United States
(12) Patent Application Publication
(10) Pub. No.: US 2017/0140048 A1
(43) Pub. Date: May 18, 2017

(54) INFORMATION PROCESSING METHOD, APPARATUS, TERMINAL AND SERVER

(71) Applicant: Xiaomi Inc., Beijing (CN)

(72) Inventors: Pingze Wang, Beijing (CN); Tao Zhang, Beijing (CN); Zhijun Chen, Beijing (CN)

(73) Assignee: Xiaomi Inc., Beijing (CN)

(21) Appl. No.: 15/354,783

(22) Filed: Nov. 17, 2016

(30) Foreign Application Priority Data
Nov. 17, 2015 (CN) 201510792570.3

(51) Int. Cl. G06F 17/30

(52) U.S. Cl. CPC G06F 17/30864; G06F 17/30312

(57) ABSTRACT

The present disclosure is directed to an information processing method, an information processing apparatus, a terminal and a server. One method of the present disclosure involves receiving one or more data templates from a remote information processing server and storing the data templates in a local database, receiving a data object from a third-party server, and when the data object has been received, determining whether the data object comprises a particular type of data, comparing a determined data type to the one or more data templates in the local database to identify a matching data template, extracting data elements from the data object using the matching data template, and utilizing the extracted data elements to automatically perform a task. The embodiments of the present disclosure may automatically identify and extract information from data objects in an accurate and efficient manner, and enable users to take certain actions using the extracted information, thereby improving a user's experience.

### RELATED APPLICATIONS

The present patent document claims the benefit of priority to Chinese Patent Application No. 201510792570.3, filed Nov. 17, 2015, and entitled “Information Processing Method, Information Processing Apparatus, Terminal and Server,” which is incorporated herein by reference in its entirety.

### TECHNICAL FIELD

The present disclosure relates to the technical field of mobile communication, and in particular relates to methods and systems for processing structured and unstructured data objects.

### BACKGROUND

The development of the internet has changed how users live their lives, as many interactions either take place on, or are facilitated by, the Internet. Users, for example, may purchase different products or book travel accommodations on different retailer websites. These interactions often times result in the generation and delivery of automated messages to the user. Websites, for example, may send a customer a purchase confirmation via e-mail for a product that they purchased and/or notify the customer that there order has shipped via a mobile text message (i.e., an SMS message). As another example, customers who book a flight through a travel agency web site may receive a ticket confirmation e-mail following their booking as well as notifications or updates regarding the flight status.

### SUMMARY

While users may want to take certain actions in response to receiving these automated messages, for example, including a product purchase within their weekly or monthly budget or adding a reminder to the user's calendar for their travel plans, taking responsive action often time requires a great deal of manual intervention, which can be a laborious process that is prone to human error. Accordingly, in order to improve the user experience, it may be helpful to simplify and/or automate the processing of messages received by a user. Challenges arise, however, where information is densely distributed within a message, and existing methods are poorly suited to accurately and efficiently extract information from a message. By leveraging the fact that automated messages generated for a particular user interaction may be similarly formatted and contain common elements of information, a prioritized template-based method for information extraction may be used to overcome the shortcomings of existing methods and automatically and accurately extract elements from a received message object.

According to a first aspect of the present disclosure, a method is provided that involves receiving one or more data templates from a remote information processing server and storing the data templates in a local database, receiving a data object from a third-party server, and when the data object has been received, determining whether the data object comprises a particular type of data, comparing a determined data type to the one or more data templates in the local database to identify a matching data template, extracting data elements from the data object using the matching data template, and utilizing the extracted data elements to automatically perform a task.

According to a second aspect of the present disclosure, a method is provided that involves receiving a plurality of data objects from one or more remote terminal devices, processing the plurality of data object to identify one or more data fields, generating one or more data templates based on the identified data fields, and distributing the data templates to the one or more remote terminal devices.

According to a third aspect, a message transmission apparatus is provided, which includes a processor and a memory for storing instructions executable by the processor, wherein the processor is configured to receive one or more data templates from a remote information processing server and store the data templates in a local database, receive a data object from a third-party server, and when the data object has been received, determine whether the data object comprises a particular type of data, compare a determined data type to the one or more data templates in the local database to identify a matching data template, extract data elements from the data object using the matching data template, and utilize the extracted data elements to automatically perform a task.

According to a fourth aspect, a message transmission apparatus is provided, which includes a processor and a memory for storing instructions executable by the processor, wherein the processor is configured to receive a plurality of data objects from one or more remote terminal devices, process the plurality of data object to identify one or more data fields, generate one or more data templates based on the identified data fields, and distribute the data templates to the one or more remote terminal devices.

It should be understood that both the foregoing summary and the following detailed description are only exemplary and explanatory and are not restrictive of the invention.

### BRIEF DESCRIPTION OF THE DRAWINGS

The innovation may be better understood with reference to the following drawings and description. In the figures, like reference numerals designate corresponding parts throughout the different views.

FIG. 1 illustrates an example of a system environment in which different devices may interact.

FIG. 2 illustrates some of the logic that may be employed by an information processing server to generate a keyword template.

FIG. 3 illustrates some of the logic that may be employed by a terminal device to extract information from a received message using a keyword template and use the extracted information to perform certain additional tasks.

FIG. 4 is a block diagram showing an information processing apparatus according to an exemplary embodiment.

FIG. 5 is a block diagram showing another information processing apparatus according to exemplary embodiment.

FIG. 6 is a block diagram showing another information processing apparatus according to an exemplary embodiment.

FIG. 7 is a block diagram showing another information processing apparatus according to an exemplary embodiment.

FIG. 8 is a block diagram showing another information processing apparatus according to an exemplary embodiment.

FIG. 9 is a block diagram showing another information processing apparatus according to an exemplary embodiment.

FIG. 10 is a block diagram showing another information processing apparatus according to an exemplary embodiment.

FIG. 11 is a block diagram showing another information processing apparatus according to an exemplary embodiment.

FIG. 12 is a block diagram showing another information processing apparatus according to an exemplary embodiment.

FIG. 13 is a block diagram showing another information processing apparatus according to an exemplary embodiment.

FIG. 14 is a block diagram showing another information processing apparatus according to an exemplary embodiment.

FIG. 15 is a block diagram showing another information processing apparatus according to an exemplary embodiment.

FIG. 16 is a block diagram showing another information processing apparatus according to an exemplary embodiment.

FIG. 17 is a block diagram showing another information processing apparatus according to an exemplary embodiment.

FIG. 18 is a block diagram showing another information processing apparatus according to an exemplary embodiment.

FIG. 19 is a block diagram showing another information processing apparatus according to an exemplary embodiment.

FIG. 20 is a block diagram showing another information processing apparatus according to an exemplary embodiment.

FIG. 21 is a block diagram showing another information processing apparatus according to an exemplary embodiment.

FIG. 22 is a block diagram showing another information processing apparatus according to an exemplary embodiment.

FIG. 23 is a block diagram showing another information processing apparatus according to an exemplary embodiment.

FIG. 24 is a block diagram showing another information processing apparatus according to an exemplary embodiment.

FIG. 25 is a block diagram showing another information processing apparatus according to an exemplary embodiment.

FIG. 26 is a block diagram showing another information processing apparatus according to an exemplary embodiment.

FIG. 27 is a diagram showing a structure of an information processing apparatus according to an exemplary embodiment.

FIG. 28 is a diagram showing a structure of another information processing apparatus according to an exemplary embodiment.

### DETAILED DESCRIPTION

Reference will now be made in detail to exemplary embodiments, examples of which are illustrated in the accompanying drawings. The implementations set forth in the following description of exemplary embodiments do not represent all implementations consistent with the present disclosure. Instead, they are merely examples of systems, apparatuses and methods consistent with aspects of the present disclosure, which may be recited in the appended claims.

In the present disclosure, the terms used are aimed at describing the specific embodiments but not limiting the present disclosure. The terms “a”, “the” and “this” used in the present disclosure and the accompanying claims which are in singular forms are also aimed at comprising plural forms, unless the context clearly indicates other meanings. It shall also be appreciated that the terms “and/or” used in the text refers to one or more correlated items listed, comprising any or all possible combinations thereof.

It shall be appreciated that, although terms such as first, second and third may be employed in the present disclosure to describe various elements, the elements should not be thus limited. These terms are only used to distinguish elements of the same type from each other. For example, in a case not departing from the scope of the present disclosure, a first element may also be called a second element, and similarly, the second element may be referred to as the first element. Furthermore, depending on the context, the word “if” used herein can be explained as “while . . . ” or “when . . . ” or “responsive to a determination that . . . .”

### System Environment

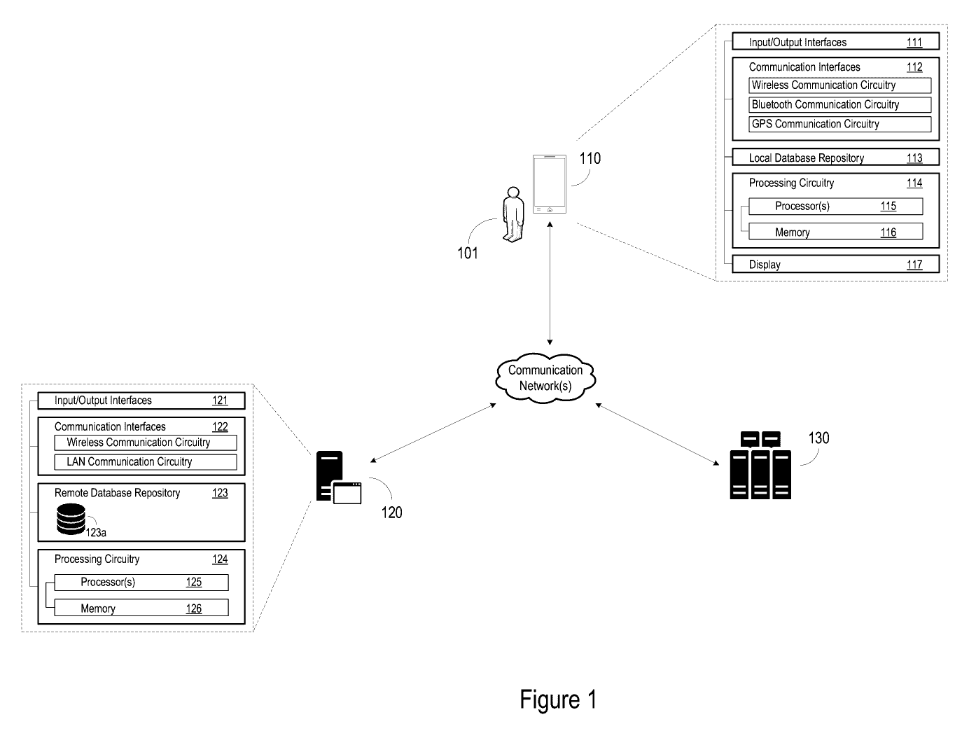

FIG. 1 illustrates an example of a system environment in which different devices may interact. The system environment 100 may include one or more terminal devices 110, which may be operated by one or more users 101, an information processing server 120 and one or more third-party servers 130. The terminal devices 110, information processing server 120 and third-party servers 130 may communicate with one another via the communication network(s) 150.

The communication network(s) 150 may be a public network, such as the Internet, a private network, such as an intranet, or a combination thereof, and may include intermediate network devices or logic operating according to any communication mediums, protocols, topologies, or standards. The communication networks 150, for example, may include terrestrial networks, including as examples, Ethernet, cable, DSL, Multimedia over Coax Alliance, power line, Ethernet Passive Optical Network (EPON), or Gigabit Passive Optical Network (GPON) networks, cellular networks, including standards-based networks (e.g., 2G, 3G, Universal Mobile Telecommunications System (UMTS), GSM® Association, Long Term Evolution (LTE)™, or more), WiMAX networks, Bluetooth networks, near field communication (NFC) networks, WiFi (including 802.11 a/b/g/n/ac or others) networks, WiGig networks, Global Positioning System (GPS) networks, any other networks available at the time of the filing of this application, and/or networks that may be developed in the future.

The terminal devices 110 may be any intelligent terminal having communication capabilities, for example, taking the form of a smartphone, tablet computer, PDA (Personal Digital Assistant), or other similar devices. As illustrated in FIG. 1, the terminal device 110 may be a smartphone including one or more input/output interfaces 111, one or more communication interfaces 112, a local database repository 113, processing circuitry 114, including one or more processors 115 and memory 116, and a display 117, which may all be in electronic communication with one another. The communication interfaces 112 may include wireless communication circuitry, Bluetooth communication circuitry, NFC communication circuitry, or the like. The terminal device 110 may use the one or more communication interfaces 112 to communicate with the information processing server 120 and third-party servers 130 over the communication networks 150. The local database repository 113 may store data templates for various types of information. The local database repository, for example, may store keyword templates, along with corresponding production rules and associated tags. The local database repository may also store source-type associations, and other associations, that may be utilized by the terminal device 110.

The information processing server 120 may include one or more input/output interfaces 121, one or more communication interfaces 122, a remote database repository 123, and processing circuitry 124, including one or more processors 125 and memory 126, which may all be in electronic communication with one another. The communication interfaces 122 may include wireless communication circuitry, LAN communication circuitry, or the like. The information processing server 120 may use the one or more communication interfaces 122 to communicate with the terminal devices 110 and third-party servers 130 over the communication network(s) 150. The remote database repository 123 may include a database that stores data templates for various types of information. The remote database repository 123, for example, may include a keyword template database 123a, which may store keyword templates, along with corresponding production rules and associated tags, for various types of information. The keyword template database 123a may also store source-type associations, and other associations, that are maintained by the information processing server 120.

The third-party servers 130 may be any system with which a terminal device 110 or information processing server 120 may interact with. By way of example, a user 101 may use their terminal device 110 to make a purchase with an e-commerce platform operated on a third-party server 130 of a retailer. As another example, a user 101 may use their terminal device 110 to book a train ticket on a travel agency website (i.e., a third-party server 130), which may generate an automated message for the terminal device 110 or information processing server 120 confirming that the ticket has been booked and providing details regarding the booking (e.g., train number, seat number, time of departure, etc.). The third-party server 130 may then transmit the generated message to the terminal device 110 of the user 101 and/or the information processing server 120. In some embodiments, the automated messages may be sent directly to the terminal device 110 and/or information processing server 120. In other implementations, the automated messages may be sent directly to the terminal device 110, which may in turn relay the message to the information processing server 120, or to the information processing 120, which may in turn relay the message to the terminal device 110. The third-party server 130 may deliver the automated message to the terminal device 110 and/or information processing server 120 using any mode currently in existence or to be developed in the future, for example, transmitting the automated message via e-mail or mobile messaging (e.g., MMS or SMS messaging) over the communications network 150. While the following description may make reference to the examples of a purchase confirmation or a train ticket booking, it should be appreciated that the scope of the present disclosure is not thus limited and may be readily adapted to messages containing different types of information.

As it relates to the processing of messages received (either directly or indirectly) from third-party servers 130, the terminal device 110 and/or information processing server 120 may be responsible for the generation of one or more keyword templates. The keyword templates may be exchanged directly between terminal devices 110 or indirectly through the information processing server 120. The terminal devices 110 in processing subsequently received messages may rely on available keyword templates to automatically extract information elements from incoming messages. The terminal device 110 in selecting a keyword template to use for processing an incoming message may perform a topological sorting of the keyword templates to identify the most applicable keyword template. While the topological sorting scheme is sufficiently efficient, barriers may arise when dealing with a large number of keyword templates. In such circumstances, filter conditions may be applied to obtain a limited set of matching keyword templates from which the most applicable keyword template may be selected. It may also be the case that none of the keyword templates are found to be applicable, in which case the terminal device 110 may analyze the message itself and generate a keyword template, which may then be sent to the information processing server 120, or relay the message to the information processing server 120 for analysis and keyword template generation. The keyword template that is found to be most applicable may be used to extract the relevant information elements from the incoming message object. And, in some cases, certain tasks may be automatically triggered in the terminal device 110 and/or at the information processing server 120.

In processing incoming messages, the terminal device 110 and information processing server 120 may implement various natural language processing (NLP) techniques to analyze structured or unstructured information (e.g., an incoming message object). For example, whether processed by the terminal device 110 or information processing server 120, the automated messages may be used to generate one or more keyword templates. In doing so, the terminal device 110 and/or information processing server 120 may perform one or more natural language processing functions including, for example, tokenization, text segmentation and sentence detection, part-of-speech tagging, named entity recognition, dependency parsing, and semantic class identification. The information processing server 120 and/or terminal devices 110 may process received messages using a pipelined approach. The information processing server 120, for example, may use ClearNLP, Stanford's CoreNLP, which are generally available as an open-source product, or some other commercial natural language parsers, which may be built upon Apache's Unstructured Information Management Architecture (UIMA), which is also available an open-source product

Based on the implementation, the terminal device 110 and information processing server 120 may be configured to perform NLP tasks independently or in a coordinated fashion. By way of example, the information processing server 120 may generate one or more keyword templates and distribute some or all of the keyword templates to terminal devices 110. The terminal devices 110 may then perform a topological sorting of the keyword templates and extract information elements from incoming messages based on matching keyword templates. Based on the extracted information elements, the terminal devices 110 may automatically take certain actions and/or invoke certain actions by the information processing server 120. The terminal device 110 and information processing server 120, in order to assist with taking certain actions, may access context specific information (e.g., weather information, traffic information, travel guides, etc.) from the third-party servers 130.

### Generating Keyword Templates

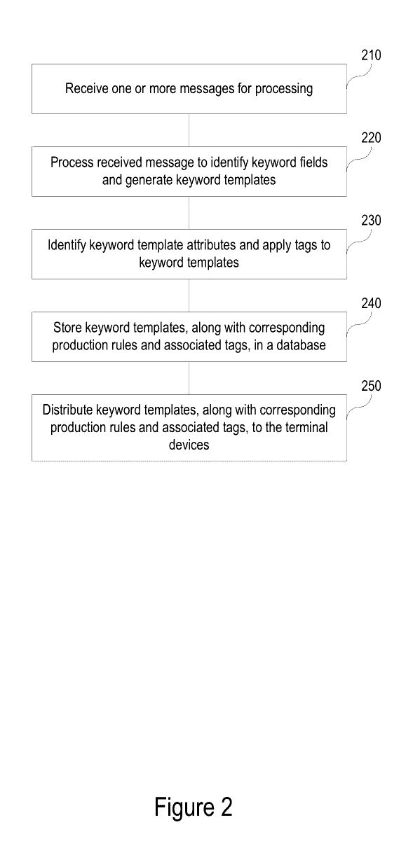

As mentioned above, the terminal device 110 and/or information processing server 120 may generate one or more keyword templates. FIG. 2 illustrates some of the logic that may be employed by an information processing server 120 to generate keyword templates that may provide a set of rules that may be applied to a subsequently received message to extract significant elements of information (i.e., those corresponding to particular keyword fields), which may be used in further processing.

The information processing server 120 may receive one or more messages for processing (210). As noted above, in some implementations, the information processing server 120 may receive the automated messages directly from third-party servers 130. In other implementations, the terminal devices 110 may receive automated messages from third-party servers 130 and may forward the messages on to the information processing server 120. The messages may be automatically forwarded to the information processing servers 120 upon receipt by the terminal devices 110. Alternatively, the messages may be sent from the terminal device 110 to the information processing servers 120 in an asynchronous fashion. The terminal device 110, for example, may send received messages to the server once an hour or once a day.

The information processing server 120 may process the received messages to identify one or more keyword fields corresponding to significant information elements within the received messages and generate one or more keyword templates, which may be used to extract information from newly received messages that may be matched to the keyword template (220). In doing so, the information processing server 120 may take advantage of the fact that automated messages generated by a third-party system 130 for a particular user interaction may contain common information elements and be similarly formatted and structured. The information processing server 120 may process the messages as they are received or may aggregate messages (e.g., those received within a set period of time) for batch processing. The information processing server 120 may utilize a set of one or more of the same type of automated message to “train” itself to identify patterns within a particular message and across multiple messages. In some implementations, for instance, the information processing server 120 may employ vocabulary-syntactic pattern matching techniques in order to identify significant keyword fields, which is suited for intensive knowledge extraction with a high level of accuracy. The information processing server 120 may perform a syntactic analysis on a segmented message to map specific elements to common field names according to predefined mapping relationships and rules. In other implementations, the information processing server 120 may also employ different analytical approaches to identify structural and syntactic patterns across messages and identify common keyword fields. The keyword fields in a particular keyword template may be associated with the type of information included in the received messages from which it was generated, and referenced using a respective identifier. When applied to subsequent messages, the elements in the message corresponding to the keyword fields may be extracted and separately stored as a specific instance of the template, having a corresponding instance identifier.

The keyword templates that are generated may employ a context-free grammar (CFG) that specifies a set of rules (or productions) for the template. Each rule has a left-hand side, which may include a non-terminal symbol (e.g., an expression starting with “<?”), and a right-hand side, which may define its alternative component parts. The keyword template itself may be represented as a production. By way of example, the information processing server 120 may receive the following message (hereinafter referred to as the “First Message”), confirming the purchase of a train ticket, from a terminal device 110 of a user:
[China Railway Customer Service] Order No. 12345678, Mr. Zhang, you have bought a ticket for train G7566, carriage 05, seat No. 10B on June 26, depart from Hefei South at 13:44. Zhang Wuji, please exchange for a paper ticket as soon as possible.
   The information processing server 120 may process the message and identify the order number, name of the passenger, departure date, train number, carriage number, seat number, departure date, departure station, and departure time as keyword fields within the message, and may generate the following keyword template (hereinafter referred to as the “First Template”) as a result:
<?train ticket order template 1>→[China Railway Customer Service] Order No. <?order number>, <?appellation>, you have bought a ticket for train <?train number>, carriage <?carriage number>, seat <?seat number>on <?departure date>, depart from <?departure station>at <?departure time>. <?passenger>, please exchange for a paper ticket as soon as possible.
   The ticket information keyword template illustrated above may additionally employ the following productions:

| | |
|---|---|
| <?order number> | → <#ENG><#NUM> |
| <?appellation> | → Mr. <*> \| Ms. <*> |
| <?departure date> | → MM dd |
| <?train number> | → <#ENG><#NUM>\|<#NUM> |
| <?carriage number> | → <#NUM> |
| <?seat number> | → <#NUM><#ENG>\|<#NUM> |
| <?departure station> | → <*> |
| <?departure time> | → HH:mm |
| <?passenger> | → <*> |

As used in the productions above, “|” represents a logical or, “<#ENG>” matches with an English character string, “<#NUM>” matches with a numerical character string, “MM”, “dd”, “HH” and “mm” respectively match with month, day, hour, and minute, “<*>” matches with any character string.

As another example, the information processing server 120 may receive the following message (hereinafter referred to as the “Second Message”), confirming the purchase of a train ticket for two passengers, from a terminal device 110 of a user:
[Railway Customer Service] Order No. 12345679, Mrs. Zhang, you have bought tickets for train D8045, carriage No. 06, seat No. 03A and seat No. 03B on April 14, depart from Anshan West at 11:09. Zhang Wuji, Zhao Min, please exchange for paper tickets as soon as possible.
   The information processing server 120 may process the message and generate the following keyword template (hereinafter referred to as the “Second Template”):

<?train ticket order template 2> → [Railway Customer Service]
Order number <?order number>, <?appellation>, you have
bought tickets for train <?train number>, carriage
<?carriage number>, seat <?seat number 1> and seat <?seat
number 2> on <?departure date>, depart from <?departure station>
at <?departure time> . <?passenger 1>, <?passenger 2>, please
exchange for paper tickets as soon as possible.

The template may employ the following productions, which as can be seen may be recursive in nature, in addition to those identified in the previous example:

<?seat number 1> → <?seat number>
<?seat number 2> → <?seat number>
<?passenger 1> → <?passenger>
<?passenger 2> → <?passenger>

While the above examples may specify particular keyword fields in a ticket information template, it should be understood that the ticket information template is not thus limited. A ticket information template, for example, may contain other keyword fields that may be found in ticket purchase confirmation messages including, for example, an arrival station, a seat type (e.g., sleeping berth, hard seat, second class seat, business class seat, etc.), a type of train, an estimated time of travel, or the like.

The information processing server 120 may also apply tags to the keyword templates that may identify particular attributes or qualities associated with the keyword template (230). The keyword templates, for example, may be given tags that identify the type of information to which the keyword template may apply and/or the source of the information to which the keyword template may apply. As a more specific example, the keyword templates described above may be given a “ticket confirmation” tag, as they would apply to messages containing ticket confirmation information, and/or a tag of “China Railway,” as the confirmation message may be generated in response to a purchase made through China Railway's e-commerce platform. As another example, the keyword templates may be tagged based on the source of the received messages that were used to generate the keyword template, for example, the e-mail address, telephone number, or partial telephone number (e.g., a common prefix or suffix) from which the received message was sent. In some embodiments, the information processing server 120 may also identify and maintain associations between different information sources (e.g., information source tags) and the type of information that may be provided by those sources. The information processing server 120, for example, may associate China Railway (i.e., an information source) with ticket confirmation information (a type of information).

The generated keyword templates, along with their corresponding production rules and associated tags, and any source-type associations may be stored in the keyword template database 123a on the information processing server 120 (240). The information processing server 120 may also use the received messages to test (i.e., validate or invalidate) existing keyword templates and ensure that keyword templates adapt to changes in the format and structure of the message (e.g., addition of a new term). The information processing server 120 may also distribute the keyword templates to the terminal devices 110 (250), which may use the information in processing newly received messages, as detailed below. The information may be distributed to the terminal devices 110 in response to update requests received from the terminal devices 110, or may be automatically pushed to the terminal devices 110 by the information processing server 120 at periodic intervals (e.g., every hour) or on an event-driven basis (e.g., as new templates are generated or existing templates are modified). In some implementations, the terminal device 110 may request a limited set of keyword templates by specifying certain filter criteria (e.g., a particular source association).

While some of the logic above is described with reference to the information processing server 120, the terminal device 110 may be similarly configured to process messages to generate one or more keyword templates. The terminal device 110, for example, may receive one or more messages from different third-party servers 130, and may process the received messages to identify one or more keyword fields within the received messages and generate one or more keyword templates as described above. The terminal device 110 may process the messages as they are received and/or process messages that may have been aggregated over a period of time. The terminal device 110 may also apply tags to the keyword templates and identify and maintain source-type associations. The keyword templates, along with their corresponding production rules and associated tags, and any source-type associations may be stored in the local database repository 113, which may be used by the terminal device 110 in processing newly received messages, as detailed below. While the current description may be provided with reference to keyword templates that are generated by processing messages, the present disclosure is not thus limited and may more broadly apply to the processing of structured or unstructured data objects (e.g., messages, images, videos, or the like) to identify significant data fields (e.g., keyword fields) within the data objects relating to a particular type of information and generate a data template (e.g., a keyword template), which may subsequently be used to extract information from newly received data objects.

### Extracting Information Using Keyword Templates

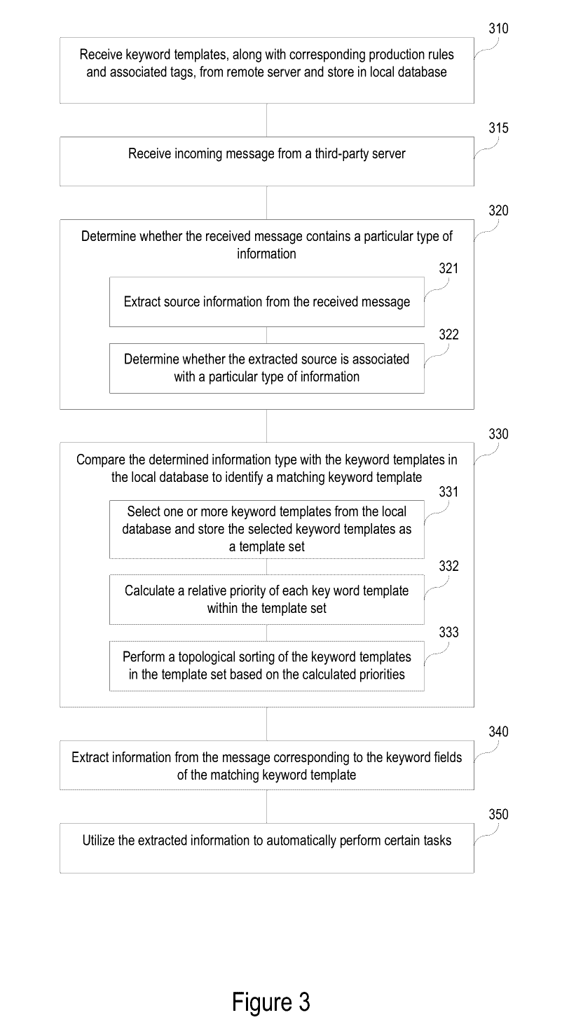

FIG. 3 illustrates some of the logic that may be employed by a terminal device to extract information from a received message using a keyword template and use the extracted information to perform certain additional tasks. At a high level, the terminal device 110 may receive an incoming message, determine the type of information contained within the message, match the determined type of information to a keyword template stored in a local database, extract particular elements from the incoming message using the matching keyword template, and utilize the extracted information to automatically perform certain additional tasks. In this way, the terminal device 110 is able to accurately and efficiently extract information from received messages, which the terminal device 110 may use in automating other tasks for the user thereby improving the user experience.

In greater detail, the terminal device 110 of a user may receive one or more keyword templates, along with their corresponding production rules and associated tags, from the remote information processing server 120, and may store the received keyword templates in a local database repository 113 (310). The terminal device 110 may also receive source-type associations from the information processing server 120, which may also be stored in the local database repository 113. The information stored in the local database repository 113 may be updated based on requests sent from the terminal device 110 to the information processing server 120, which may be sent periodically (e.g., every 3 hours) or on an on-demand basis (e.g., when a new message is received for processing), or may be updated whenever update data is pushed to the device from the information processing server 120.

The terminal device 110 may receive an incoming message from a third-party server 130 (315). The terminal device 110, for example, may receive an e-mail or text message from a ticket-booking agency confirming the purchase of a ticket by the user. The user, for instance, may have purchased a ticket (e.g., train ticket, an airline ticket, an entrance ticket, a movie ticket, a theater ticket, etc.) from a ticket-booking agency website, which may have generated the confirmation message and sent it to the terminal device 110 of the user in response. The terminal device 110 may process the message to determine whether it contains, or pertains to, a particular type of information (320). The terminal device 110, for example, may process the message received from the ticket-booking agency and determine that the message pertains to ticket information for a ticket that the user purchased. Next, the terminal device 110 may compare the determined type of information to the database of keyword templates stored on the terminal device 110 and identify a set of one or more matching keyword templates (330). The terminal device 110 may sort the keyword templates, for example, using the topological sorting approach described below, and select the highest ranked keyword template as the matching keyword template. The terminal device 110 may then extract information element from the message corresponding to the keyword fields of the matching keyword template (340). The extracted information elements may be separately stored in the local database repository as an instance of the keyword template. The terminal device 110 may utilize the extracted information to automatically perform one or more specific tasks (350).

In some embodiments, the terminal device 110, in determining whether a received message pertains to a particular type of information, may extract source information from the received message, for example, by parsing the message and identifying a company name provided in the message (e.g., the name of the ticket-booking agency for a ticket confirmation message, or the name of a bank provided in a credit card billing message) and/or a telephone number or e-mail address provided in the message, for example, within the body of the message or as part of the message itself (e.g., in the header information of the message) (321). The terminal device 110 may then determine whether the extracted source is associated with a particular type of information, for example, using the source-type associations in the local database repository 113, which are provided by the information processing server 120 (322). If a source-type association exists, the terminal device 110 may determine that the received message includes a particular type of information. If no source-type association exists, the terminal device 110 may proceed to analyze the message contents to determine a type of information contained therein.

As noted above, the information processing server 120 may provide database updates to the terminal device 110, which may include source-type associations. In the context of determining whether a source-type association exists, the terminal device 110 may issue a request (i.e., an on-demand request) to the information processing server 120 requesting an update of the source-type associations. Alternatively, the information processing server 120 may push source-type associations to the terminal device 110 as they are determined by the information processing server 120. By updating the source-type associations in this way, a more timely and accurate determination of the type of information in the received message may be obtained.

In some cases where no source-type association exists, the terminal device 110 may not have previously received a message from the particular source and may not have a keyword template corresponding to the type of information contained within the message. The terminal device 110, for example, may receive a message from a third-party server 130 for the first time, but may not have a keyword template associated with the particular source. In such cases, the terminal device 110 may process the received message to identify various keyword fields and generate a keyword template, as described above, which may be sent to the information processing server 120 and used for processing subsequent messages. In other embodiments, the received message may be sent to the information processing server 120, which may process the received message to identify keyword fields and generate a keyword template as described above.

In some embodiments, the terminal device 110, in identifying a matching keyword template for a determined type of information, may group similar keyword templates together (e.g., those templates associated with the determined type of information), store the grouped templates as a template set, sort the keyword templates in the template set based on a relative priority of the templates within the set, and select a matching keyword template from the sorted template set. In doing so, the terminal device 110 may be able to improve the efficiency of the template matching process since only a subset of the keyword templates is being considered to be a match.

By way of example, the terminal device 110 may process an incoming message to determine a source of the received information. The terminal device 110, for example, may process a ticket purchase confirmation message and determine the name of the ticket-booking agency through which the ticket was purchased. The terminal device 110 may then select one or more keyword templates from the local database repository 113 and may store, or otherwise group, the keyword templates in a template set (331). The terminal device 110, for example, may construct a mapping relationship between a particular source of, and terms in, a keyword template and a template set. As a more specific case, continuing with the previous example, the terminal device 110 may be able to group keyword templates associated with the determined ticket-booking agency in a template set, since the telephone number of a ticket-booking agency may have certain regularities (e.g., the same telephone number prefix or suffix) and the messages received from those telephone numbers contain common terms or elements (e.g., identifying the same company name).

Since the productions for a particular keyword template may include expressions that can be matched against any character string (e.g., the wildcard operator “<*>”), it may be possible for a received message to be matched with one or more keyword templates in a template set. In such cases, it may be necessary to calculate a relative priority of each keyword template to determine which keyword template may be the best match. The terminal device 110, for example, may calculate a relative priority of each key word template within the template set (332). The terminal device 110, for example, may compare each keyword template in the template set to one another. If the set of messages that match a first keyword template is a proper subset of the set of messages that match a second keyword template, the terminal device 110 may assign the first keyword template a higher relative priority value than the second keyword template. But if the set of matching messages for the first keyword template and the set of matching messages for the second keyword template are identical, the terminal device 110 may assign the same value to both the first and second keyword template. In such cases, the terminal device 110 may choose to discard (or delete) one of the keyword templates. In more general terms, where S_A and S_B represent the set of messages that can be matched against keyword template A and keyword template B, respectively, the priority of keyword template A is higher than that of keyword template B when S_A is a proper subset of S_B, the priority of keyword template B is higher than that of keyword template A when S_B is a proper subset of S_A, and the priority of keyword template A and keyword template B are the same where S_A is a subset of S_B and S_B is a subset of S_A.

As a more specific example, the terminal device 110 may receive the following message (the Second Message described earlier):
[Railway Customer Service] Order No. 12345679, Ms. Zhang, you have bought tickets for train D8045, carriage No. 06, seat No. 03A and seat No. 03B on April, 14, depart from Anshan West at 11:09. Zhang Wuji, Zhao Min, please exchange for paper tickets as soon as possible.
   The terminal device may evaluate the message against a template set that includes two different templates, wherein the first keyword template (similar to the First Template described earlier) produces the following set of matching terms:

<?seat number> matches with “03A”;
<?departure station> matches with “ [symbol] No. 03B, Anshan West”; and
<?passenger> matches “Zhang Wuji, Zhao Min”

and the second keyword template (similar to the Second Template described earlier) produces the following set of matching terms:

<?seat number 1> matches “03A”;
<?seat number 2> matches “03B”;
<?departure station> matches “Anshan West; and
<?passenger> matches “Zhang Wuji, Zhao Min”

As indicated in the received message, the user may have purchased two tickets for two seats corresponding to two passengers. Since the second keyword template includes keyword fields for a first and second seat number, the set of messages that will match it will be a proper subset of the messages that will match with the first keyword template, which only includes keyword fields for a first seat number, and so the terminal device 110 may assign the second keyword template a higher priority. With the relative priority of each keyword template within the set of templates calculated, the terminal device 110 may be able to perform a topological sorting of the keyword templates in the template set based on the calculated priorities, for example, sorting the keyword templates from high priority to low priority (333). The terminal device 110 may then select the keyword template having the highest priority as the keyword template that may best match the received message.

As noted above, the terminal device 110 may use the matching keyword template to extract information from the received message and may utilize the extracted information to automatically perform certain tasks. In some embodiments, the terminal device 110 may present the extracted information to the user via the display 117 of the terminal device 110 according to a preset display format. The terminal device 110, for example, may present the received message on the display 117 with the extracted information being identified with a visual identifier (e.g., the extracted information may be highlighted or displayed in a particular color).

In other embodiments, the terminal device 110 may analyze the extracted information and determine whether the information refers to an event. For example, the terminal device 110 may recognize that the production of a keyword field refers to a calendar date or a time of day, and may determine that the extracted information pertains to a particular event. The terminal device 110 may use the extracted information to generate a reminder note that may be stored on the terminal device 110. The terminal device 110 may add the reminder to the calendar of a user or to a task list of the user, and may do so automatically or based on the selection of a button presented to the user on the display 117. In some implementations, the reminder note may also trigger an alarm or some other notification at a predetermined time before the event is set to take place. By generating a reminder note and/or triggering a notification, the terminal device 110 may be able to provide the user with a timely reminder regarding the particular event. As an example, the terminal device 110 may recognize that a received message includes details regarding a train ticket that the user has purchased, and may schedule a notification to be presented to the user at a predetermined time (e.g., 24 hours before the scheduled departure), thereby assisting the user with managing their schedule so as to avoid missing the train departure.

In some embodiments, the terminal device 110 may also request context specific information from third party servers 130 based on information extracted from the received message using the matching keyword template. With regard to a ticket confirmation message, the terminal device 110, for example, may gather information regarding the weather, traffic information, available accommodations, local food guides, or the like based on specific details extracted from the ticket confirmation message. As a more specific example, the terminal device 110 may determine that the user is taking a business trip to a particular location based on destination and arrival date information extracted from a ticket confirmation message using a keyword template with destination and arrival date keyword fields. The terminal device 110 may then generate a query to third-party servers 130 that requests context specific information based on the extracted information (i.e., the extracted destination and arrival date). The query, for example, may request information regarding the predicted weather and suggested dress, the availability and price levels of hotels, travel suggestions and restaurant recommendations, special local products and shopping guides, or the like for the planned destination and arrival date. The third-party servers 130 may provide the requested information, which the terminal device may then present to the user via the display 117 of the terminal device 110. In this way, the terminal device 110 is able to gather and present useful information that may facilitate certain actions (e.g., help the user make travel arrangements) or conveniently provide the user with relevant information.

As another example, when a user 101 purchases certain products (e.g., clothing) from an online retailer, a confirmation message may be sent to the terminal device 110. The confirmation message may include an invoice number and/or a shipment tracking number, which the terminal device 110 may extract using a specific keyword template. The terminal device 110 may invoke a status update process by the information processing server 120, where periodic requests are made to a third-party server 130 regarding the shipping status of the order. The extracted invoice number may also trigger the addition of a debit entry in a financial planner maintained by the user 101 on the terminal device 110.

In yet other embodiments, the terminal device 110 may be able to identify patterns between received messages and take certain actions based on these observed patterns. The terminal device 110, for example, in processing ticket confirmation messages, may observe repeated occurrences of a particular flight or train (e.g., based on a common flight or train number and similar arrival information), and may determine that the trip is recurring in nature. In making the determination, the terminal device 110 may compare the number of repeated occurrences to a threshold value (e.g., requiring a minimum of 3 trips) and/or a ratio of the repeated occurrences to the total number of trips taken within a specified period of time to a threshold value (e.g., requiring at least 50% of the trips within the past month). If a recurring trip is identified, the terminal device 110 may be able to predict when the next trip may take place, and may generate a reminder notification providing the user with a reminder to purchase a ticket before the predicted date of the next trip. In some embodiments, the terminal device 110 may be able to automatically book a ticket for the next predicted trip, or may communicate with a ticket-booking agency to book a ticket at a fixed time. Further, in some embodiments, the terminal device 110 may be able to monitor pricing information for the predicted trip and book the ticket at an optimal price. The terminal device 110 may also provide the user with context specific information (e.g., weather conditions at the departure and arrival stations) regarding the predicted trip, as described above. In some cases, the terminal device 110 may also provide the user with discounts or promotions (e.g., hotel discount information) regarding the trip.

While the logic above is described with reference to the terminal device 110, the information processing server 120 may similarly extract information from a received message using a keyword template and use the extracted information to perform certain additional tasks. The information processing server 120, for example, may receive an incoming message, determine the type of information contained within the message, match the determined type of information to a keyword template stored in a local database, extract particular elements from the incoming message using the matching keyword template, and utilize the extracted information to automatically perform certain additional tasks as described above. In some implementations, the terminal device 110 may simply provide the information processing server 120 with extracted information, which may be processed to trigger certain actions. And in yet other implementations, both the terminal device 110 and information processing server 120 may process the extracted information to automatically perform certain tasks.

Corresponding to the embodiments of the aforementioned information processing method, the present disclosure also provides embodiments of an information processing apparatus, and a terminal and a server where it may be employed.

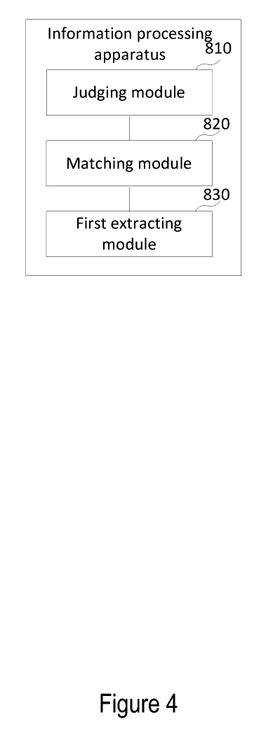

As shown in FIG. 4, FIG. 4 is a block diagram showing an information processing apparatus according to an exemplary embodiment of the present disclosure, and the apparatus may comprise: a judging module 810, a matching module 820 and a first extracting module 830. The judging module 810 may be configured to, when information is received, judge whether the information is a predetermined type of information; the matching module 820 may be configured to, when the judging module 810 judges that the information is the predetermined type of information, match the predetermined type of information with a key word template; and the first extracting module 830 may be configured to extract key information in the information based on the key word template successfully matched by the matching module 820. The key word template matched by the matching module 820 comprises a plurality of key words which are individually stored. Optionally, each key word in the key word template matched by the matching module 820 may be identified individually using a preset identifier to construct a template structure.

In the above embodiment, the terminal can judge whether the received information is the predetermined type of information, when the information is the predetermined type of information, match the predetermined type of information with a key word template, and then extract key information in the information based on the successfully matched key word template. The present disclosure may be able to accurately identify and extract key information such as train number, seat, departure/arrival station, departure/arrival time, order number, passenger in ticket information in which the key information is distributed very intensively, so as to remind the user based on the key information, and thereby improves the user experience.

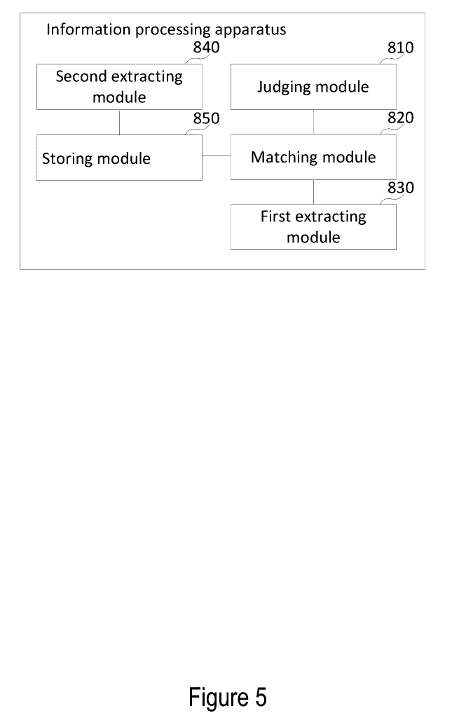

As shown in FIG. 5, FIG. 5 is a block diagram showing another information processing apparatus according to an exemplary embodiment of the present disclosure. On the basis of the embodiment shown in FIG. 4, the apparatus may also comprise: a second extracting module 840 and a storing module 850. The second extracting module 840 may be configured to extract a name of a ticket-booking agency in the key word template; and the storing module 850 may be configured to store key word templates having the same name of a ticket-booking agency extracted by the second extracting submodule 840 in a same template set. In this embodiment, the terminal can store the key word templates pertaining to a same ticket-booking agency in the same template set, so as to improve accuracy and efficiency of the subsequent matching of the templates.

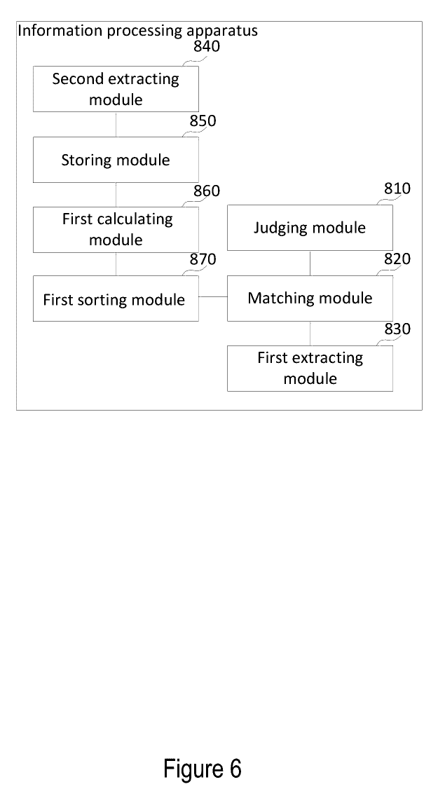

As shown in FIG. 6, FIG. 6 is a block diagram showing another information processing apparatus according to an exemplary embodiment of the present disclosure. On the basis of the embodiment shown in the above FIG. 5, the apparatus may also comprise: a first calculating module 860 and a first sorting module 870. The first calculating module 860 may be configured to, for each template set, perform a priority calculation to each key word template comprised in the template set based on a matching set thereof; and the first sorting module 870 may be configured to perform a topological sorting to each key word template pertaining to a same template set based on the priority calculated by the first calculating module 860. In the above embodiment, the terminal can perform a priority calculation to the key word templates in a same template set, and perform sorting based on the priority, so that when the same information can be successfully matched with a plurality of key word templates, the information may be matched to the key word template that has the highest priority.

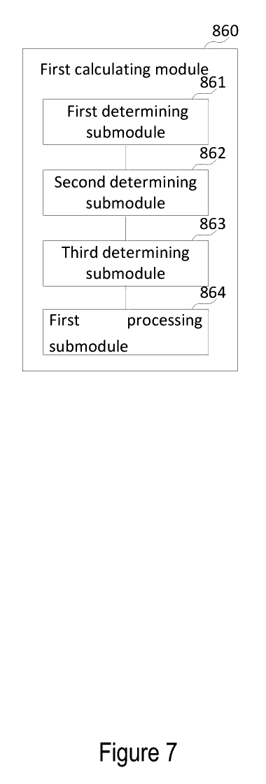

As shown in FIG. 7, FIG. 7 is a block diagram showing an information processing apparatus according to an exemplary embodiment. On the basis of the embodiment shown in the above FIG. 5, the first calculating module 860 may comprise: a first determining submodule 861, a second determining submodule 862, a third determining submodule 863 and a first processing submodule 864. The first determining submodule 861 may be configured to determine a short message set that can be matched with each key word template in the template set; the second determining submodule 862 may be configured to, when the first determining submodule 861 determines one short message set as a proper subset of another short message set, determine that the priority of the key word template corresponding to the one short message set is higher than the priority of the key word template corresponding to the another short message set; the third determining submodule 863 may be configured to, when the second determining submodule 862 determines one short message set as identical to another short message set, determine that the priority of the key word template corresponding to the one short message set is the same as the priority of the key word template corresponding to the another short message set; and the first processing submodule 864 may be configured to retain one of the key word templates having the same priority as determined by the third determining submodule 863, and delete other key word templates having the same priority. In the above embodiment, the terminal can determine the priority based on a short message set that can be matched to each key word template, and for the key word templates having the same priority, only one key word template is retained, so as to prevent redundant information from occupying the memory.

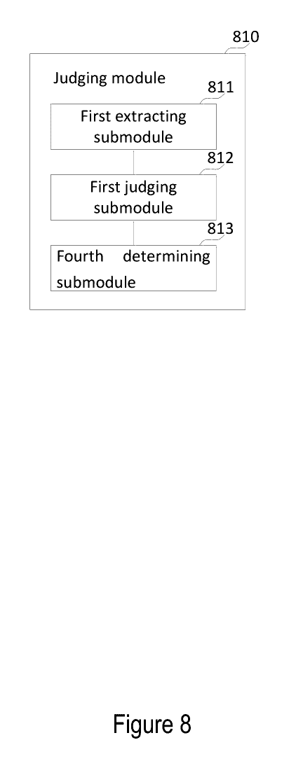

As shown in FIG. 8, FIG. 8 is a block diagram showing another information processing apparatus according to an exemplary embodiment of the present disclosure. On the basis of the embodiment shown in the above FIGS. 4-7, the judging module 810 may comprise: a first extracting submodule 811, a first judging submodule 812 and a fourth determining submodule 813. The first extracting submodule 811 may be configured to extract source information in the information, which source information comprising a name of a ticket-booking agency and/or a number of an income message; the first judging submodule 812 may be configured to judge whether the source information extracted by the first extracting submodule 811 is a source of the predetermined type of information; and the fourth determining submodule 813 may be configured to, when the first judging submodule 812 judges that the source information is the source of the predetermined type of information, determine the information as the predetermined type of information. In the above embodiment, the terminal can determine whether the information is the predetermined type of information (i.e., the ticket information) based on source information of the information, i.e., the company name or the number of the income message in the information, and such a method can accurately determine whether the information is the predetermined type of information.

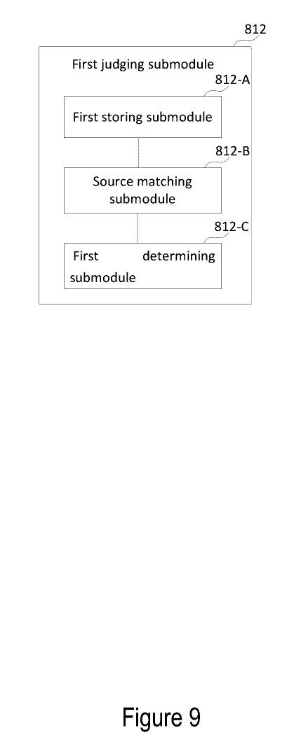

As shown in FIG. 9, FIG. 9 is a block diagram showing another information processing apparatus according to an exemplary embodiment of the present disclosure. On the basis of the embodiment shown in the above FIG. 8, the first judging submodule 812 may comprise: a first storing submodule 812-A, a source matching submodule 812-B and a first determining submodule 812-C. The first storing submodule 812-A may be configured to receive and store the source information sent by a server; the source matching submodule 812-B may be configured to match the source information in the information with the source information stored in the first storing submodule 812-A; and the first determining submodule 812-C may be configured to, when the source matching submodule 812-B successfully matches the source information in the information with the stored source information, determine the source information in the information as the source of the predetermined type of information. In the above embodiment, the terminal can receive and store the source information sent by the server, and match the source information in the received information with the stored source information.

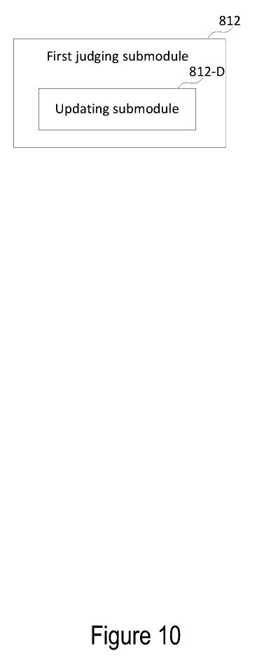

As shown in FIG. 10, FIG. 10 is a block diagram showing another information processing apparatus according to an exemplary embodiment of the present disclosure. On the basis of the embodiment shown in the above FIG. 9, the first judging submodule 812 further comprises: an updating submodule 812-D. The updating submodule 812-D may be configured to, when the source updated information sent by the server is received, update the stored source information based on the source updated information. In the above embodiment, the terminal can update the stored source information when it receives the source updated information sent by the server, so that it always stores the latest source information.

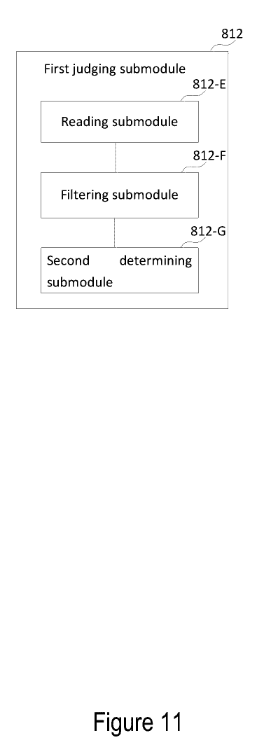

As shown in FIG. 11, FIG. 11 is a block diagram showing another information processing apparatus according to an exemplary embodiment of the present disclosure. On the basis of the embodiment shown in the above FIG. 8, the first judging submodule 812 may further comprise: a reading submodule 812-E, a filtering submodule 812-F and a second determining submodule 812-G. The reading submodule 812-E may be configured to read a preset filtering condition; the filtering submodule 812-F may be configured to filter the source information in the information based on the filtering condition read by the reading submodule 812-E; and the second determining submodule 812-G may be configured to determine the source information that matches with the filtering condition as the source of the predetermined type of information. In the above embodiment, the terminal can set a filtering condition, and match the source information with the filtering condition, so as to filter out information from the source of the predetermined type of information.

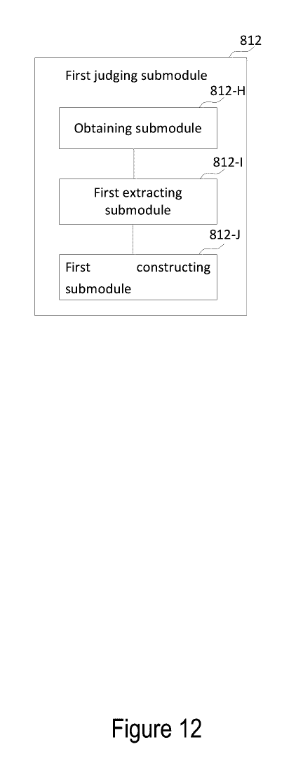

As shown in FIG. 12, FIG. 12 is a block diagram showing another information processing apparatus according to an exemplary embodiment of the present disclosure. On the basis of the embodiment shown in the above FIG. 11, the first judging submodule 812 may also comprise: an obtaining submodule 812-H, a first extracting submodule 812-I and a first constructing submodule 812-J. The obtaining submodule 812-H may be configured to obtain the predetermined type of information received within a set time period; the first extracting submodule 812-I may be configured to extract key words in the predetermined type of information obtained by the obtaining submodule 812-H; and the first constructing submodule 812-J may be configured to construct a key word template based on the key words extracted by the first extracting submodule 812-I. In the above embodiment, the terminal can construct a key word template based on the key words in the predetermined type of information.

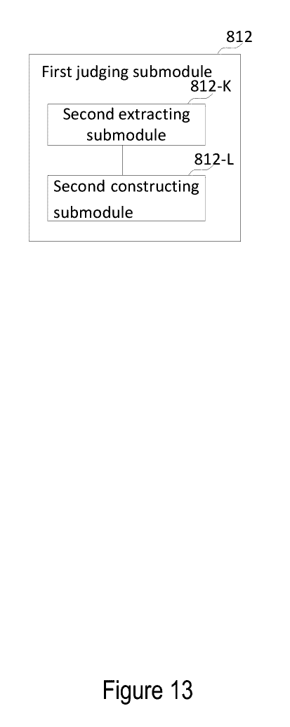

As shown in FIG. 13, FIG. 13 is a block diagram showing another information processing apparatus according to an exemplary embodiment. On the basis of the embodiment shown in the above FIG. 11, the first judging submodule 812 may further comprise: a second extracting submodule 812-K and a second constructing submodule 812-L. The second extracting submodule 812-K may be configured to, when information conforming to the filtering condition is received for the first time, and no key word template corresponding to the information is stored, extract the key words in the information; and the second constructing submodule 812-L may be configured to construct a key word template based on the key words extracted by the second extracting submodule 812-K. In the above embodiment, when the terminal receives information conforming to the filtering condition for the first time and does not store a key word template corresponding to the information, it construct a key word template based on the key words in the information.

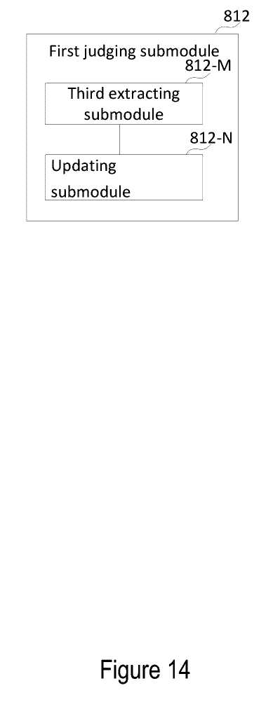

As shown in FIG. 14, FIG. 14 is a block diagram showing another information processing apparatus according to an exemplary embodiment of the present disclosure. On the basis of the embodiment shown in the above FIG. 13, the first judging submodule 812 may further comprise: a third extracting submodule 812-M and an updating submodule 812-N. The third extracting submodule 812-M may be configured to, when information conforming to the filtering condition is received subsequently, extract the key words in the received information; and the updating submodule 812-N may be configured to regulate and update the key word template based on the key words extracted by the third extracting submodule 812-M. In the above embodiment, the terminal can regulate and update the constructed key word template based on the subsequently received information conforming to the filtering condition, so as to improve the matching accuracy for the key word template.

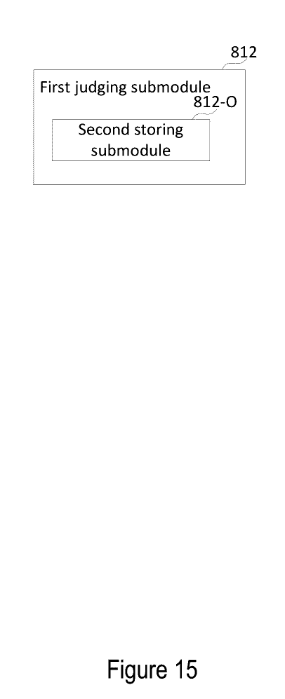

As shown in FIG. 15, FIG. 15 is a block diagram showing another information processing apparatus according to an exemplary embodiment of the present disclosure. On the basis of the embodiments shown in the above FIG. 9 or 11, the first judging submodule 812 may also comprise: a second storing submodule 812-O. The second storing submodule 812-O may be configured to, when the source information comprising the filtering condition is the source information that has not been stored, individually store the source information in the key word template. In the above embodiment, the terminal can individually store the source information comprising filtering condition that has not been stored in the key word template to enrich the contents of the key word template, thereby improving accuracy for the matching.

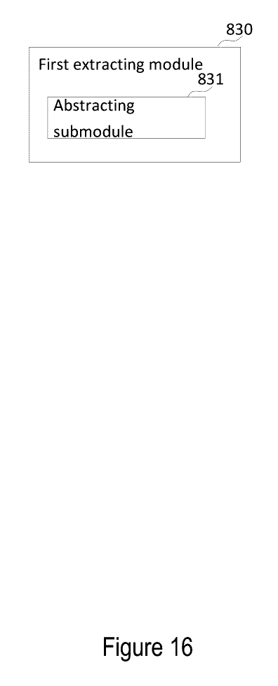

As shown in FIG. 16, FIG. 16 is a block diagram showing another information processing apparatus according to an exemplary embodiment of the present disclosure. On the basis of the embodiment shown in the above FIG. 4, the first extracting module 830 may comprise: an extracting submodule 831. The extracting submodule 831 may be configured to extract key information corresponding to the preset identifier from the information based on the template structure of the successfully matched key word template. In the above embodiment, the terminal can extract the key information utilizing a template-based method, thereby realizing the accurate extraction of intensive knowledge.

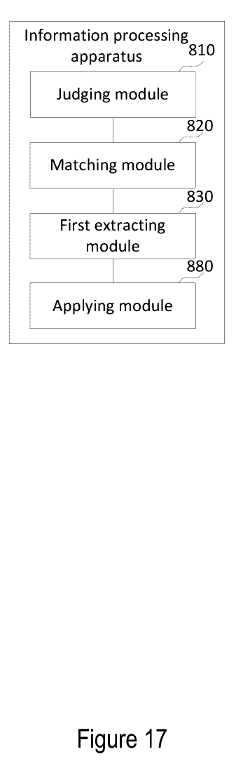

As shown in FIG. 17, FIG. 17 is a block diagram showing another information processing apparatus according to an exemplary embodiment of the present disclosure. On the basis of the embodiment shown in any one of the above FIGS. 4-7, the apparatus may also comprise: an applying module 880. The applying module 880 may be configured to apply the key information.

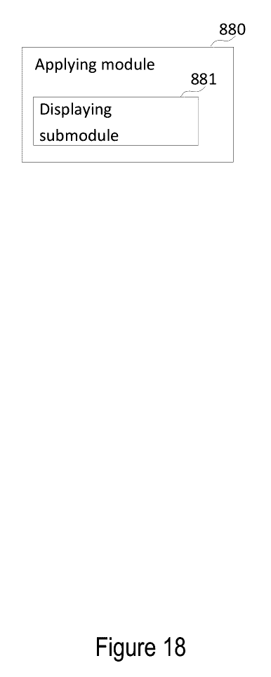

As shown in FIG. 18, FIG. 18 is a block diagram showing another information processing apparatus according to an exemplary embodiment of the present disclosure. On the basis of the embodiment shown in the above FIG. 17, the applying module 880 may comprise: a display submodule 881. The display submodule 881 may be configured to display the key information with a preset display format. In the above embodiment, the terminal can display the key information in a preset display format such as color and arrangement, so that the user can quickly get the key information.

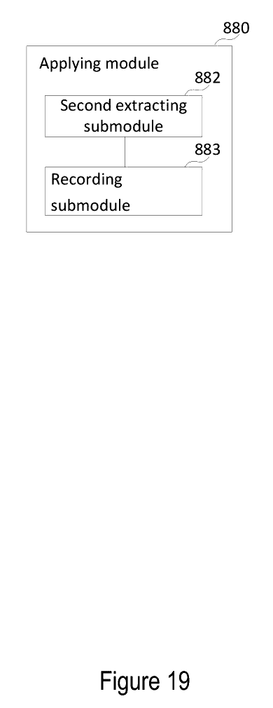

As shown in FIG. 19, FIG. 19 is a block diagram showing another information processing apparatus according to an exemplary embodiment of the present disclosure. On the basis of the embodiment shown in the above FIG. 17, the applying module 880 may also comprise: a second extracting submodule 882 and a recording submodule 883. The second extracting submodule 882 may be configured to extract key event information in the key information; and the recording submodule 883 may be configured to record the key event information extracted by the second extracting submodule 882 in a notepad/reminder time. In the above embodiment, the terminal can record the key event information in the key information in a notepad or a reminder time, so as to remind the user to prevent the user from forgetting important events.

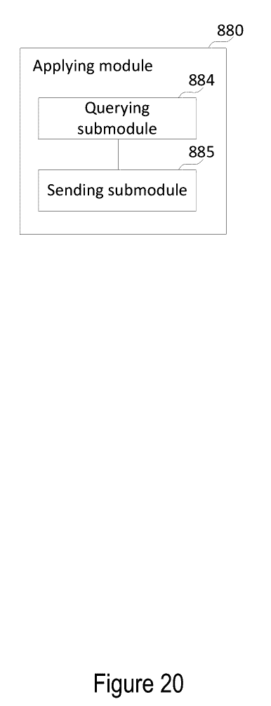

As shown in FIG. 20, FIG. 20 is a block diagram showing another information processing apparatus according to an exemplary embodiment of the present disclosure. On the basis of the embodiment shown in the above FIG. 17, the applying module 880 may also comprise: a querying submodule 884 and a sending submodule 885. The querying submodule 884 may be configured to query life information based on a date in the key information; and the sending submodule 885 may be configured to send the life information queried by the querying submodule 884 to a user, wherein, the life information comprises one or more of weather information, accommodation information, dietary information, dressing information, traffic information, shopping information and communication information. In the above embodiment, the terminal can obtain life information based on the key information, which facilitates trips of the user, provides conveniences in various aspects for the user and improves the user experience. The embodiments of the information processing apparatus as shown in FIG. 4 to FIG. 20can be applied in a terminal.

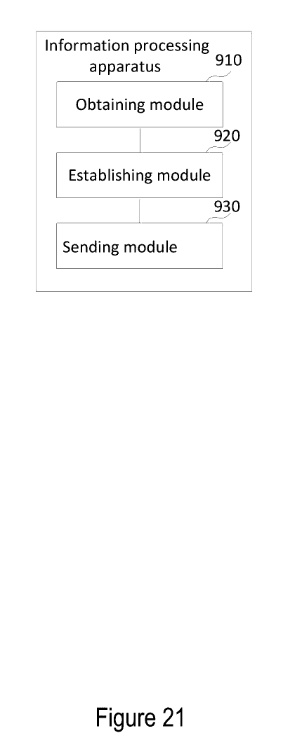

As shown in FIG. 21, FIG. 21 is a block diagram showing another information processing apparatus according to an exemplary embodiment, and the apparatus may comprise: an obtaining module 910, an establishing module 920 and a sending module 930. The obtaining module 910 may be configured to obtain information received within a set time period; the establishing module 920 may be configured to establish a key word template based on key words in the information obtained by the obtaining module 910; and the sending module 930 may be configured to send the key word template established by the establishing module 920 to a terminal to cause the terminal to, when receiving the predetermined type of information, extract key information in the predetermined type of information based on the successfully matched key word template. In the above embodiment, the server can establish a key word template based on key words in the plurality of information and send the constructed key word template to the terminal, so that the terminal, when receiving a predetermined type of information, can extract the key information based on the successfully matched key word template, which facilitates reminding to the user based on the key information, and thereby improves the user experience.

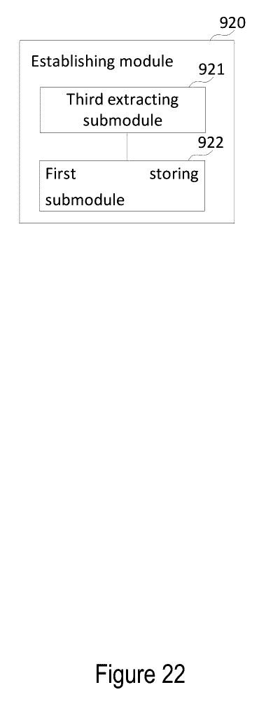

As shown in FIG. 22, FIG. 22 is a block diagram showing another information processing apparatus according to an exemplary embodiment of the present disclosure. On the basis of the embodiment shown in the above FIG. 21, the establishing module 920 may comprise: a third extracting submodule 921 and a first storing submodule 922. The third extracting submodule 921 may be configured to extract key words in the information; and the first storing submodule 922 may be configured to individually identify each key word extracted by the third extracting submodule 921 using a preset identifier, and individually store each key word in the constructed key word template. In the above embodiment, the server can individually identify the key word using a preset identifier, and individually store each key word in the constructed key word template.

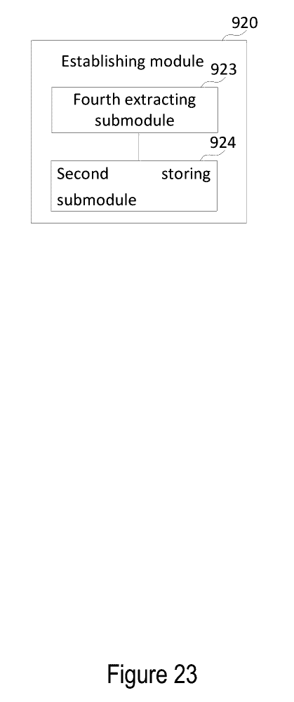

As shown in FIG. 23, FIG. 23 is a block diagram showing another information processing apparatus according to an exemplary embodiment of the present disclosure. On the basis of the embodiment shown in the above FIG. 22, the establishing module 920 may also comprise: a fourth extracting submodule 923 and a second storing submodule 924. The fourth extracting module 923 may be configured to extract a name of a ticket-booking agency in the key word template; and the second storing submodule 924 may be configured to store the key word templates having the same name of a ticket-booking agency extracted by the fourth extracting submodule 923 in a same template set. In the above embodiment, the server can store key word templates of a same ticket-booking agency in a same template set, so as to improve the efficiency of the subsequent template matching.

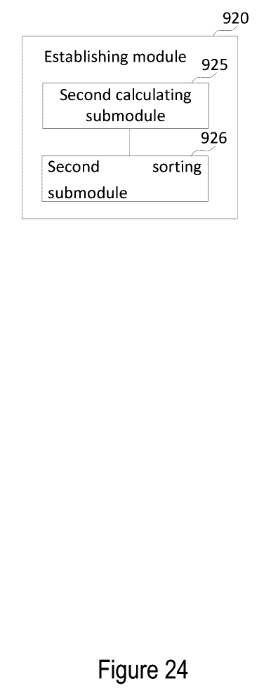

As shown in FIG. 24, FIG. 24 is a block diagram showing another information processing apparatus according to an exemplary embodiment of the present disclosure. On the basis of the embodiment shown in the above FIG. 23, the establishing module 920 may also comprise: a second calculating submodule 925 and a second sorting submodule 926. The second calculating module 925 may be configured to, for each template set, perform a priority calculation to each key word template comprised in the template set based on a matching set thereof; and the second sorting module 926 may be configured to perform a topological sorting to each key word template pertaining to a same template set based on the priority calculated by the second calculating module 925. In the above embodiment, the server can perform a priority calculation to the key word templates in a same template set, and perform sorting based on the priority, so that when the same information can be successfully matched with a plurality of key word templates, the information is matched to the key word template that has the highest priority.

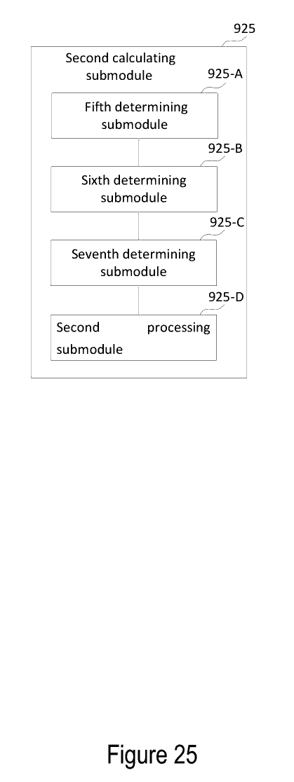

As shown in FIG. 25, FIG. 25 is a block diagram showing another information processing apparatus according to an exemplary embodiment. On the basis of the embodiment shown in the above FIG. 22, the second calculating submodule 925 may comprise: a fifth determining submodule 925-A, a sixth determining submodule 925-B, a seventh determining submodule 9253 and a second processing submodule 925-D. The fifth determining submodule 925-A may be configured to determine a short message set that can be matched with each key word template in the template set; the sixth determining submodule 925-B may be configured to, when the fifth determining submodule 925-A determines one short message set as a proper subset of another short message set, determine that the priority of the key word template corresponding to the one short message set is higher than the priority of the key word template corresponding to the another short message set; the seventh determining submodule 925-C may be configured to, when the sixth determining submodule 925-B determines one short message set as identical to another short message set, determine that the priority of the key word template corresponding to the one short message set is the same as the priority of the key word template corresponding to the another short message set; and the second processing submodule 925-D may be configured to retain one of the key word templates having the same priority as determined by the seventh determining submodule 925-C, and delete other key word templates having the same priority. In the above embodiment, the server can determine the priority based on a short message set that can be matched to each key word template, and for key word templates having the same priority, only one key word template is retained, so as to prevent redundant information from occupying the memory.

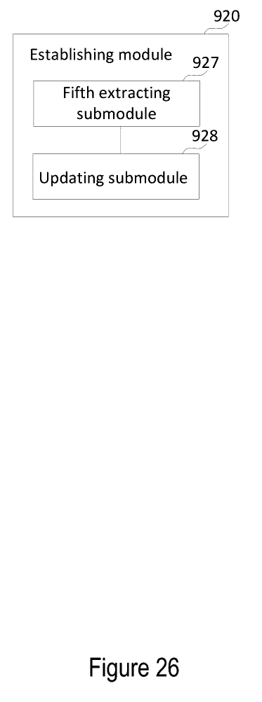

As shown in FIG. 26, FIG. 26 is a block diagram showing another information processing apparatus according to an exemplary embodiment of the present disclosure. On the basis of the embodiment shown in the above FIG. 21, the establishing module 920 may also comprise: a fifth extracting submodule 927 and an updating submodule 928. The fifth extracting submodule 927 may be configured to, when an information arranging format of the received information is inconsistent with a stored information arranging format, extract the key words in the information; and the updating submodule 928 may be configured to update the corresponding key word template based on the key words extracted by the fifth extracting submodule 927. In the above embodiment, when the arranging format of the received information is inconsistent with the stored arranging format, the server can update the corresponding key word template based on the key words, so as to ensure an accuracy of the key word template. The embodiment of the information processing apparatus as shown in the above FIGS. 21-26 can be applied in the server for constructing a key word template.

Reference can be made to the implementing process of the corresponding steps in the above methods for the detailed implementing process of the functions and effects of each module in the above apparatus, which will not be elaborated herein. Since the apparatus embodiments substantially correspond to the method embodiments, similar parts of the method embodiments may be referred to for the apparatus embodiments. The apparatus embodiments above may be realized by software, hardware or a combination thereof. The apparatus embodiments, for example, may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components. The above apparatus embodiments are illustrative only. The modules described as separate members may be or may not be physically separated. The members described as modules may be or may not be physical modules, may be located at the same place or may be distributed in multiple network modules. The objectives of the solutions of this disclosure may be realized by selecting some or all of the modules according to the actual needs. The above can be understood and implemented by those skilled in the art without any inventive work.

Corresponding to FIG. 4, the present disclosure also provides a terminal that may include a processor and a memory for storing instructions executable by the processor, wherein, the processor may be configured to: receive one or more data templates from a remote information processing server and store the data templates in a local database; receive a data object from a third-party server, and when the data object has been received, determine whether the data object comprises a particular type of data; compare a determined data type to the one or more data templates in the local database to identify a matching data template; extract data elements from the data object using the matching data template; and utilize the extracted data elements to automatically perform a task.

Corresponding to FIG. 21, the present disclosure also provides a server that may include a processor and a memory for storing instructions executable by the processor, wherein, the processor may be configured to: receive a plurality of data objects from one or more remote terminal devices; process the plurality of data object to identify one or more data fields; generate one or more data templates based on the identified data fields; and distribute the data templates to the one or more remote terminal devices.

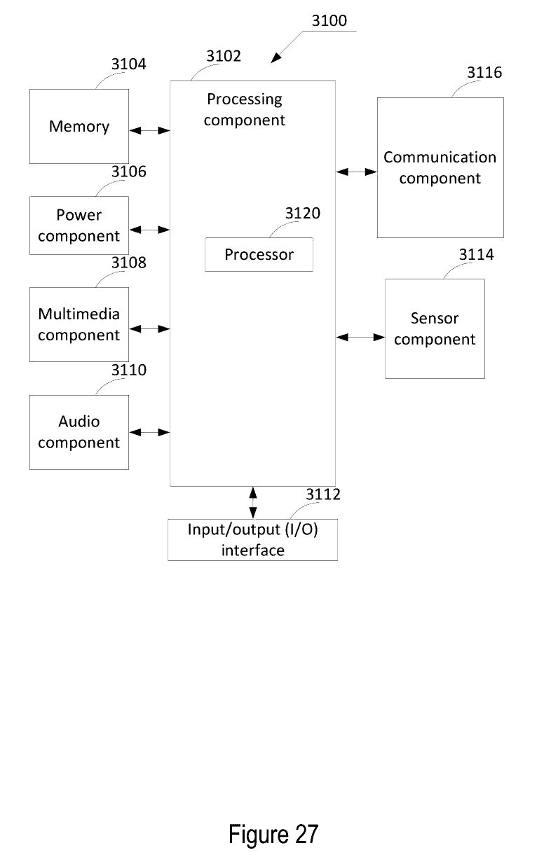

FIG. 27 provides a diagram showing a structure (e.g., a terminal device 110) of an information processing apparatus 3100 according to an embodiment of the present disclosure. For example, the apparatus 3100 may be a mobile phone, a computer, a digital broadcast terminal, a message sending and receiving equipment, a game console, a tablet device, a medical device, a fitness equipment, a personal digital assistant or the like that have a routing function.

As illustrated in FIG. 27, the apparatus 3100 can comprise one or more of the following components: a processing component 3102, a memory 3104, a power component 3106, a multimedia component 3108, an audio component 3110, an input/output (I/O) interface 3112, a sensor component 3114 and a communication component 3116.

The processing component 3102 may control overall operation of the apparatus 3100, such as the operations associated with display, telephone calls, data communications, camera operations, and recording operations. The processing component 3102 may include one or more processors 3120 to execute instructions to perform all or part of the steps in the above described methods. Moreover, the processing component 3102 may include one or more modules which facilitate the interaction between the processing component 3102 and other components. For instance, the processing component 3102 may include a multimedia module to facilitate the interaction between the multimedia component 3108 and the processing component 3102.

The memory 3104 may be configured to store various types of data to support the operation of the apparatus 3100. Examples of such data include instructions for any applications or methods operated on the apparatus 3100, contact data, phonebook data, messages, pictures, video, etc. The memory 3104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 3106 may provide power to various components of the apparatus 3100. The power component 3106 may include a power management system, one or more power sources, and any other components associated with the generation, management, and distribution of power in the apparatus 3100.

The multimedia component 3108 may include a screen providing an output interface between the apparatus 3100 and the user. In some embodiments, the screen may include a liquid crystal display (LCD) and a touch panel (TP). If the screen includes a touch panel, the screen can be implemented as a touch screen to receive input signal from the user. The touch panel includes one or more touch sensors to sense touches, swipes and gestures on the touch panel. The touch sensor may not only sense a boundary of a touch or swipe action, but also a period of time and a pressure associated with the touch or swipe action. In some embodiments, the multimedia component 3108 may include a front camera and/or a rear camera. The front camera and the rear camera may receive an external multimedia datum while the apparatus 3100 is in an operation mode, such as a photographing mode or a video mode. Each of the front camera and the rear camera may be a fixed optical lens system or can have focal lengths and optical zoom functionality.

The audio component 3110 may be configured to output and/or input audio signals. For example, the audio component 3110 may include a microphone (“MIC”) configured to receive an external audio signal when the apparatus 3100 is in an operation mode, such as a call mode, a recording mode, or a voice recognition mode. The received audio signal may be further stored in the memory 3104 or transmitted via the communication component 3116. In some embodiments, the audio component 3110 may further include a speaker to output audio signals.

The I/O interface 3112 may provide an interface between the processing component 3102 and peripheral interface modules, such as a keyboard, a click wheel, buttons, and the like. The buttons may include, but are not limited to, a home button, a volume button, a starting button, and a locking button.

The sensor component 3114 may include one or more sensors to provide status assessments of various aspects of the apparatus 3100. For instance, the sensor component 3114 may detect an open/closed status of the apparatus 3100, relative positioning of components, e.g., the display and the keypad, of the apparatus 3100, a change in position of the apparatus 3100 or a component of the apparatus 3100, a presence or absence of user contact with the apparatus 3100, an orientation or an acceleration/deceleration of the apparatus 3100, or a change in temperature of the apparatus 3100. The sensor component 3114 may include a proximity sensor configured to detect the presence of nearby objects without any physical contact. The sensor component 3114 may also include a light sensor, such as a CMOS or CCD image sensor, for use in imaging applications. In some embodiments, the sensor component 3114 may also include an accelerometer sensor, a gyroscope sensor, a magnetic sensor, a pressure sensor, a microwave sensor or a temperature sensor.

The communication component 3116 may be configured to facilitate communication, wired or wirelessly, between the apparatus 3100 and other devices. The apparatus 3100 can access a wireless network based on a communication standard, such as WiFi, 2G, or 3G, or a combination thereof. In one embodiment, the communication component 3116 may receive a broadcast signal or broadcast associated information from an external broadcast management system via a broadcast channel. In another embodiment, the communication component 3116 may further include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or other technologies.

In various embodiments, the apparatus 3100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods. Some embodiments may also include a non-transitory computer-readable storage medium including instructions, such as included in the memory 3104, executable by the processor 3120 in the apparatus 3100, for performing the above-described methods. For example, the non-transitory computer-readable storage medium may be a ROM, a RAM, a CD-ROM, a magnetic tape, a floppy disc, an optical data storage device, and the like.

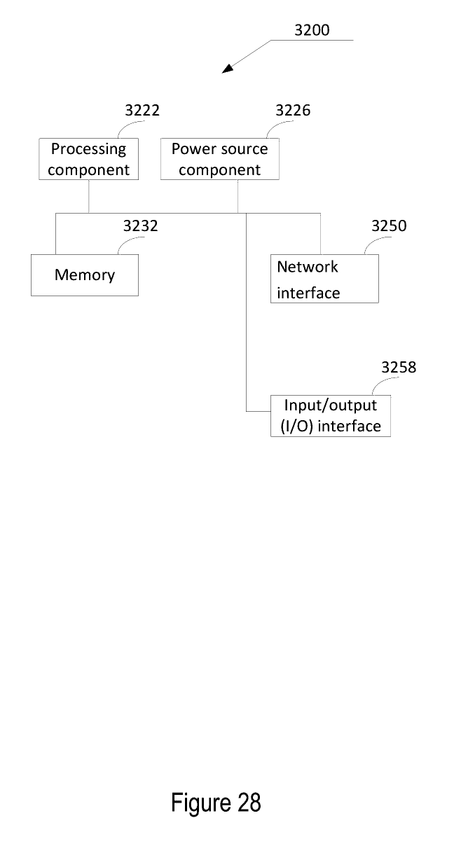

FIG. 28 provides a diagram showing a structure (e.g., an information processing server 120) of an information processing apparatus 3200 according to another embodiment of the present disclosure. For example, the apparatus 3200 may be provided as a router equipment. As illustrated in FIG. 32, the apparatus 3200 may include a processing component 3222, which may include one or more processors, and a storage resource represented by the memory 3232 for storing instructions executable by the processing component 3222, such as application programs. The application programs stored in the memory 3232 may include one or more modules each corresponds to a set of instructions. In addition, the processing component 3222 may be configured to execute instructions, so as to perform the above described methods. The apparatus 3200 may also include a power source component 3226, which may be configured to execute power management for the apparatus 3200, a wired or wireless network interface 3250 which may be configured to connect the apparatus 3200 to a network, and an input/output (I/O) interface 3258. The apparatus 3200 can operate an operating system stored in the memory 3232, for example, Windows Server™, Mac OS X™, Unix™, Linux™, Free BSD™ or the like.

Other embodiments of the present disclosure will be apparent to those skilled in the art from consideration of the specification and practice of the embodiments disclosed herein. The present disclosure is intended to cover any variations, uses, or adaptations of the disclosed embodiments that follow the general principles thereof and include such departures from the present disclosure as come within known or customary practice in the art. It is intended that the specification and examples be considered as exemplary only, with the true scope and spirit of the invention only being limited by the appended claims.

1. An information processing method, comprising:
receiving one or more data templates from a remote information processing server and storing the data templates in a local database;
receiving a data object from a third-party server, and when the data object has been received, determining whether the data object comprises a particular type of data;
comparing a determined data type to the one or more data templates in the local database to identify a matching data template;
extracting data elements from the data object using the matching data template; and
utilizing the extracted data elements to automatically perform a task.

2. The method according to claim 1, wherein each of the one or more data templates comprises a plurality of data fields that are individually stored.

3. The method according to claim 2, wherein each data field in a particular data template is identified using a respective identifier.

4. The method according to claim 1, further comprising:
determining a source of the received data object;
selecting one or more data templates from the local database that are associated with the determined source of the received data object; and
storing the selected data templates as a template set.

5. The method according to claim 4, further comprising:
calculating a relative priority of each data template in the template set; and
performing a topological sorting of the one or more data templates in the template set based on their relative priorities.

6. The method according to claim 5, wherein calculating a relative priority of each data template in the template set further comprises:
comparing the data object to each data template in the template set to determine a set of matching data elements;
when one set of matching data elements is a proper subset of another set of matching data elements, assigning the data template corresponding to the one set of matching data elements a higher priority than the data template corresponding to the another set of matching data elements; and
when one set of matching data elements is identical to another set of matching data elements, assigning the corresponding data templates the same priority, and deleting the data template corresponding to the one set of matching data elements or the data template corresponding to the another set of matching data elements.

7. The method according to claim 1, wherein determining whether the data object comprises the particular type of data comprises:
extracting source information from the received data object; and
determining whether the extracted source information is associated with a particular type of data; and
when the extracted source information is associated with the particular type of data, determining that the received data object comprises the particular type of data.

8. The method according to claim 7, wherein determining whether the extracted source information is associated with the particular type of data comprises:
receiving source-type associations from the remote server and storing them in the local database;
comparing the extracted source information to the stored source-type associations;
and when the extracted source information is successfully matched to a particular source-type association in the stored source-type associations, determining that the extracted source information is associated with the particular type of data.

9. The method according to claim 8, further comprising:
transmitting an update request to the remote server requesting an update of the source-type associations;
receiving a source-type associations update from the remote server; and
updating the stored source-type associations based on the received source-type associations update.

10. The method according to claim 7, wherein determining whether the source information is associated with the particular type of data comprises:
reading a set of one or more filtering conditions;
filtering the extracted source information of the received data object based on the set of filtering conditions; and
determining that the received data object comprises the particular type of data when the set of filtering conditions are met.

11. The method according to claim 10, further comprising:
when the received data object meets the set of filtering conditions for a first time and no data template corresponding to the particular type of data is stored in the local database:
identifying one or more data fields in the received data object;
generating a new data template based on the identified data fields; and
storing the new data template in the local database.

12. The method according to claim 11, further comprising:
when a subsequently received data object meets the set of filter conditions, identifying one or more data fields in the subsequently received data object; and
updating the new data template based on the data fields identified in the subsequently received data object.

13. The method according to claim 8, further comprising:
when the extracted source information cannot be matched to a particular source-type association in the stored source-type associations, storing the extracted source information in the data template individually.

14. The method according to claim 3, wherein extracting data elements from the data object using the matching data template comprises:
extracting data elements in the data object corresponding to the plurality of data fields of the matching data template.

15. The method according to claim 1, wherein utilizing the extracted data elements to automatically perform a task further comprises:
displaying the extracted data elements on a display using a preset display format.

16. The method according to claim 1, wherein utilizing the extracted data elements to automatically perform a task further comprises:
analyzing the extracted data elements to determine whether the extracted data elements reference an event; and
when the extracted data elements reference the event, generating an event reminder based on the extracted data elements and storing the event reminder.

17. The method according to claim 1, wherein utilizing the extracted data elements to automatically perform a task further comprises:
generating a query requesting context specific information from a third-party server based on the extracted data elements;
transmitting the query to the third-party server; and
presenting a response received from the third-party server in response to the query on a display.

18. A terminal comprising a processor and a memory for storing instructions executable by the processor, wherein the processor is configured to:
receive one or more data templates from a remote information processing server and store the data templates in a local database;
receive a data object from a third-party server, and when the data object has been received, determine whether the data object comprises a particular type of data;
compare a determined data type to the one or more data templates in the local database to identify a matching data template;
extract data elements from the data object using the matching data template; and
utilize the extracted data elements to automatically perform a task.

19. A server comprising a processor and a memory for storing instructions executable by the processor, wherein the processor is configured to:
receive a plurality of data objects from one or more remote terminal devices;
process the plurality of data object to identify one or more data fields;
generate one or more data templates based on the identified data fields; and
distribute the data templates to the one or more remote terminal devices.
